(19) United States
(12) Patent Application Publication
(10) Pub. No.: US 2022/0082717 A1
(43) Pub. Date: Mar. 17, 2022

(54) ACCELEROGRAPH AND EMBEDDED PROTOCOL FOR STRUCTURAL HEALTH MONITORING OF CIVIL ENGINEERING STRUCTURERS REGARDING EARTHQUAKE PERFORMANCE

(71) Applicant: Structures & Sensors Private Company, Athens (GR)

(72) Inventors: Stavro Chatzieleftheriou, Athens (GR); Spyridon Damikoukas, Athens (GR); Nikolaos Lagaros, Athens (GR)

(21) Appl. No.: 17/425,569

(22) PCT Filed: Jan. 29, 2020
(86) PCT No.: PCT/GR2020/000010

§ 371 Date: Jul. 23, 2021

(30) Foreign Application Priority Data
Feb. 1, 2019 (GR) 20190100049

(51) Int. Cl. G01V 1/18; G01V 1/24

(52) U.S. Cl. CPC G01V 1/18; G01V 1/247

(57) ABSTRACT

Accelerometer measuring and recording instrument which automatically performs seismic assessment of building structures. The main scope of the instrument described is civil engineering buildings. It is manufactured using low cost sensor (1) and control unit (2) (low level microcontrollers). By combining proper sensor mounting time (1) and proper automated data processing, the dynamic characteristics of the structures (natural frequencies of vibration) can be accurately derived. The seismic assessment is then extracted by applying the guidelines of modem earthquake regulations defining the performance point for the targeted displacement of an input earthquake. In order to obtain the result, the elements used are the measured eigenfrequencies of the building, the standard Push Over curves for each building category that are parameterized in the instrument memory and the input data through which the category to which the building under measurement belongs is determined. These standard Push Over curves are automatically corrected to match the results of the measurements.

### FIELD OF THE INVENTION

The present invention relates to an accelerograph which automatically performs seismic assessment of building structures. The main scope of the instrument described is civil engineering building structures. The description includes the physical implementation of the instrument along with the layout of the embedded electronic circuit, the programming for its proper operation, the method of installation as well as the automated methodology—protocol followed for the seismic assessment of building structures.

### BACKGROUND OF THE INVENTION

There are numerous devices for measuring and recording acceleration. Examples include force balance accelerometers in combination with data loggers. There are also smaller-sized and lower-precision accelerometers (e.g. MEMS type) integrated into chips which are then integrated into the appropriate electronic boards depending on the application. Noteworthy accelerometers are used to record seismic activity with the characteristic of relatively high cost. In the current state of the art, seismic assessment of building structures is carried out after laborious calculations have been made while possibly taking into account the results of some measurements and tests in order to guide and verify the accuracy of the assumptions and calculations. This way, however, it requires specialized engineers to be hired for several hours, which increases the cost. The other alternative is the optical inspection, which, however, lags behind in accuracy and any measured quantities for verification. Without measured quantities for verification, it is possible to omit existing invisible defects or adopt false assumptions.

### GENERAL DESCRIPTION OF THE INVENTION

The system introduces a new concept, that of automated seismic assessment:

“Automated seismic assessment is the method that can have the most technical and scientific accuracy in estimating the seismic behavior of a structure given the absence of a structural model built by a human user or of performing separate calculations for each different case. This can be achieved by combining both the technical knowledge and the results of modern computational tools (Pushover analysis) to categorize the behavior of structures based on common features and on the other hand the measurement results from sensors temporarily or permanently installed on the structures.”

The development of the described instrument was made with the ultimate aim of reducing costs and being widely applicable in measuring the response of structures from very small to moderate stimuli (seismic or other). This is achieved by using low cost sensors and low-level microcontrollers. This results in an autonomous instrument of minimal volume. The instrument is placed at the top of the building (e.g. the last significant concrete slab). By combining a suitable mounting time with an appropriate method of processing the micro vibration data, the dynamic characteristics of the structures can be accurately obtained. Secondly, after the main features of the building have been introduced into the memory of the instrument such as load bearing construction material, height, number of the floors, date of design and construction, earthquake regulation used, regularity or not in floor plan and height, existence of soft floors (pilots), etc., the seismic evaluation of the particular building construction is automatically extracted in the sense of exceeding or not the performance level for the target displacement as defined by modern anti-seismic regulations (e.g. FEMA 356). In other words, the system through measurements and data input creates a simplified model of the building in its memory. It then gives the results, that is, the performance level, which determines the level of potential damage, either by performing a non-linear time history analysis for a given hypothetical seismic excitation or directly using the methods outlined above and using an appropriate seismic demand spectrum.

In order to obtain the above result, standard Pushover curves are preloaded in the memory of the instrument (or in the cloud using web application) and have been derived from the literature (e.g. HAZUS) or appropriate non-linear static analyses according to the typology of the buildings where the unit will be installed. Through the web application or through an appropriate file in the removable memory card of the instrument, the features that classify the building to be measured into one of the standard categories are inserted to the instrument's memory (or in the Cloud). The unit is also able to connect locally via Wi-Fi, Bluetooth or other protocol to the user's mobile phone through a suitable application (App) from which the user can enter data and interfere with the process.

### DESCRIPTION OF DEVICE IN COMBINATION WITH THE FIGURES

FIG. 1 shows the measuring instrument consisting of the following structures: Acceleration sensor—digitizer system (1), micro controller pair control system (MCUs) (2), network module (3) for sending data, external memory module (microSD Card Reader) (4) and synchronization module (5). A characteristic of the instrument being presented is the simultaneous measurement and recording at the memory card (4) of the measurements and sending them through a TCP/IP protocol implemented through appropriate network drives (Ethernet or Wi-Fi) (3), serial or other. In order to achieve a seamless measurement at predetermined times (e.g. every 5 milliseconds) given the random delay resulting from the application of TCP/IP protocols or the long-delayed memory card recording (4) two main microcontrollers (2) with sufficient buffer are used. The first microcontroller (2) undertakes the communication with the accelerator-sensor digitizer system (1) (via serial protocol) and the fast transfer to the memory of the second microcontroller (2), which undertakes the process of recording to the memory card (4) and/or sending the data through the appropriate communication protocol. Proper programming and selection of the microcontroller's buffer (2) ensures a seamless collection of measurements at clearly defined intervals without problems. Interface of the two microcontrollers (2) with the digitizer-sensor system (1), network drives (3), memory card (4), synchronization module (5) (GPS or RF connection or wired to other microcontroller system) which performs the synchronization of the instruments in the event of multiple simultaneous use of the instruments, as well as the rest of the parts, is carried out by means of a specific electronic circuit topography shown in FIG. 2. The digitizer (1) system is connected to the rest by a separate cable, this allows for the integration of various types of sensors into the instrument and gives ease of installation as well as minimizing mechanical noise due to the way of mounting.

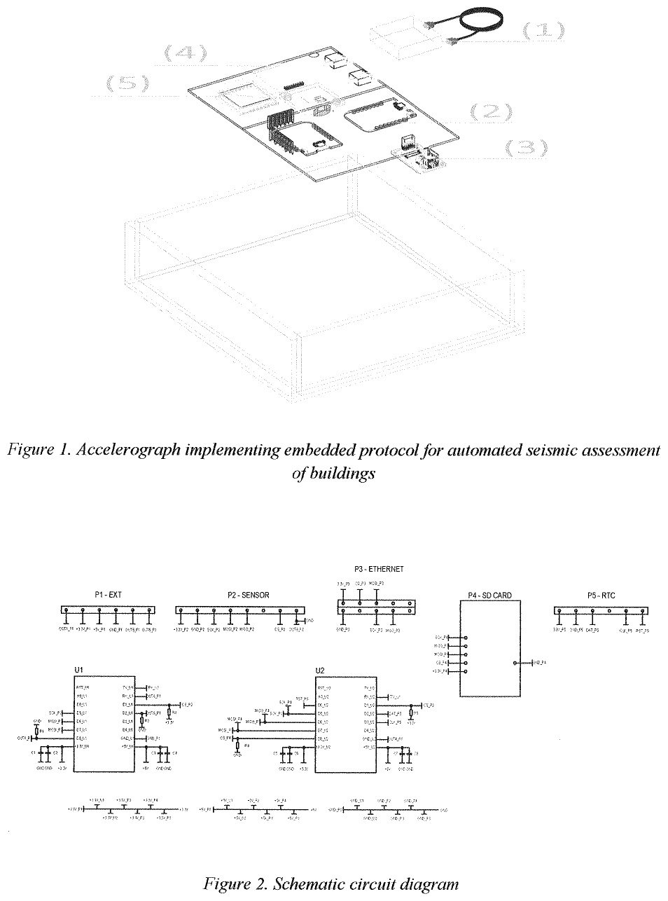

The digitizer-sensor system (1) consists of an accelerator sensor (measuring 1 to 3 dimensions), anti-aliasing, temperature sensor, analog signal amplifier, analog to digital converter and control unit.

The mounting of the digitizer-sensor system (1) is performed by the following actions: cleaning the mounting surface, coating a metal tile with resin glue, mounting the tile on the surface (e.g. concrete slab), mounting the magnet with the embedded acceleration sensor to the tile at correct orientation.

By inserting an appropriate file of structural characteristics into the removable memory card or through the mobile phone application, the category of the building being measured is determined. After completing sufficient measurement time and storing the measurements in the memory (4) of the recorder, the process of extracting the dynamic characteristics of the structure follows. To do this, the following ambient vibration measurement methodology is undertaken by performing the appropriate preloaded code by the second microcontroller:

a) Acceleration measurements (time histories) are obtained through the accelerator sensor and are stored in specific time intervals, such as two hours. These files are stored in the external memory drive (4). Then after the measurement time is completed (usually a few days), the system starts editing the stored data

b) Calculate the mean and standard deviation for each time history record. A smaller window (e.g. 30 seconds) is selected for each file in which the file is split. The average value and standard deviation are calculated for each window. If the standard deviation is greater than that of the file, the window is excluded from the calculation to maintain the windows that obey the white noise assumption and so that the micro-vibrations come from seismic-ground noise and not from stronger local or non-local excitations. The Fourier transform is calculated for each window and the mean values of the windows are obtained. The main characteristics of building structures depending on type and height and other characteristics are in the range of 0.5-10 Hz. From this element as well as the signal strength of the frequency relative to the others, the main frequency is selected. These calculations are performed by the second microcontroller and the results are recorded in a file on the external memory drive. They can also occur automatically through the cloud if there is a connection to the internet or through a local connection to the user's cell phone.

c) Pushover curves depending on the type of building are preloaded in a special file on the memory card. When entering the structural characteristics data, the curve that will be used is automatically selected. If part of the process is performed on the user's mobile phone they can also be located on a remote server and uploaded wirelessly over the internet.

d) The standard Push-Over curve in spectral acceleration-displacement diagram of the building under test is corrected so that the initial slope corresponds to the fundamental frequency measured. The rest of the curve is likewise corrected so that the ratio of the slopes before and after correction at any two points of the curve remains unchanged (New Capacity Curve). These calculations are performed by the second microcontroller and the results are recorded in a file on the external memory drive. They can also occur automatically through the cloud if there is a connection to the internet or through a local connection to the user's cell phone.

e) The combination of data and the output level of performance are performed for hypothetical seismic scenarios that are preloaded in an appropriate memory card (4) file or are input online. The results are obtained either by a non-linear time history analysis of the single-degree of freedom oscillator for a given earthquake time history whereby the performance levels results from the calculated spectral (or roof) displacement of the building, or by other equivalent methods like the Coefficient Method described in the US prestandard FEMA 356 and other.

In the above manner, the microcontroller (2), by executing an appropriate preloaded code, proceeds to extract the seismic assessment by using the measurement results (eigenfrequencies), the stored in memory (4) typical building Push-Over curves, the data that are entered in order to classify the building under measurement regarding the appropriate category and the data regarding the set of input seismic scenario. The data can also be entered into the memory (4) of the logger via the Network Module (3) by an Internet server when the proposed device has access to the Internet where it will load the necessary input data to the memory (4) connected to that server. Similarly, the results of the seismic assessment are stored in the memory (4) of the instrument from which the user can easily download to his own unit or they can be transferred to a remote server if there is an internet connection from which the user can also have direct access. Finally, another important feature of the presented instrument is that it can extract the dynamic characteristics (eigenfrequencies—eigenmodes) of the structures by using an accelerator sensor (1) with relatively high noise levels and therefore lower costs. This is achieved with increased installation time, and proper automated processing of the measurements.

1. An accelerograph instrument consisting of an accelerator-sensor-digitizer unit (1), a control unit (2), a network module (3) an external memory module (4) and a synchronization module (5) and characterized in that it performs automatically the seismic assessment of building structures.

2. The accelerograph instrument according to claim 1, characterized in that the automatic seismic assessment is performed by the control unit (2) by combining the sensor-derived (1) measurements with structural characteristics of the building inserted in memory and already parameterized typical building Push-over curves.

3. The measuring instrument of claim 1, characterized in that the accelerator sensor (1) can be of relatively high noise level and therefore of lower cost.

4. The measuring instrument of claim 1, characterized in that it is capable of connecting via Wi-Fi, Bluetooth or other protocol to the user's mobile phone or remote server through an appropriate application (App) from which the user can enter data and interfere with the process.

5. A method of seismic assessment by means of the apparatus of claim 1, comprising the following steps:
(a) Acceleration time histories recording and memory storage (4)
(b) Installation and insertion of key structural features of the structure concerned and selection of a similar preloaded standard Pushover curve on the memory card (4)
(c) Start automatic processing of signals and export of eigenfrequencies by the second microcontroller (2)
(d) Correction of the Pushover curve in a spectral acceleration—displacement diagram for the structure concerned to match the measurements on the second microcontroller (2)
(e) Using a corrected Pushover curve and the fundamental frequency to evaluate seismic performance by the second microcontroller, by non-linear time history analysis for a given earthquake time history or other equivalent methods described in seismic assessment standards and regulations.
